(19) United States
(12) Patent Application Publication
(10) Pub. No.: US 2014/0374028 A1
(43) Pub. Date: Dec. 25, 2014

(54) Labeler

(71) Applicant: KRONES AG, Neutraubling (DE)

(72) Inventors: Josef Scheck, Mintraching (DE); Ludwig Ferstl, Obertraubling (DE); Christian Stoiber, Michelsneukirchen (DE); Robert Scheibenpflug, Pfatter (DE)

(73) Assignee: KRONES AG, Neutraubling (DE)

(21) Appl. No.: 14/289,389

(22) Filed: May 28, 2014

(30) Foreign Application Priority Data
Jun. 25, 2013 (DE) 102013212133.4

(51) Int. Cl. B65C 9/26; B65C 9/40

(52) U.S. Cl. CPC B65C 9/262; B65C 9/40
USPC 156/510; 156/536

(57) ABSTRACT

A labeler for a labeling machine for attaching labels to containers, having a transfer unit for transferring the labels to the container, the transfer unit being removably fixed at an operating position. In order to allow the labeler to be operated more easily and with less problems, the transfer unit is configured such that, for removal from its operating position, it can first be moved to a handling position.

### CROSS-REFERENCE TO RELATED APPLICATION

The present application claims priority to German Application No. 102013212133.4, filed Jun. 25, 2013. The priority application, DE 102013212133.4, is hereby incorporated by reference.

### FIELD OF THE DISCLOSURE

The present invention relates to a labeler, and more specifically to a labeler for a labeling machine for attaching labels to containers, with a transfer unit for transferring labels to the container.

### BACKGROUND

A labeler is known from DE 197 58 799 B4. The known labeler is added to an automatically operating container filling line and configured either as a structural unit with a conveyor for the containers to be labeled or as a separate, replaceable labeling module. The labeler comprises the normally provided components, such as a label feeder, a gluing unit and a transfer unit configured as a gripper cylinder, said transfer unit gripping the labels, which are glue-coated or have been rendered adhesive in some other way, and applying them at the predetermined location to the containers to be labeled. The gripper cylinder rotates with its axis extending perpendicular and is driven either by a common drive together with other components of the labeler or it comprises a motor drive of its own. The gripper cylinder is equipped with peripheral gripping means, which are normally moved mechanically and are therefore comparatively heavy, a circumstance that also increases the weight of the gripper cylinder. Gripper cylinders must, however, be removed from the labeler once in a while for the purpose of inspection, maintenance or replacement. To this end, the operator stands beside the labeler and must lift the gripper cylinder upwards. Since the gripper cylinder has to be arranged approximately centrally on the labeler, the operator must lift the gripper cylinder with arms extended or almost extended. This is ergonomically unfavorable.

Comparable problems arise in the case of transfer units used for labels in labeling machines and having a structural design similar to the above-mentioned one, e.g. the vacuum cylinder according to DE 90 16 591 U1 or the blade cylinder and/or the vacuum cylinder according to EP 0 365 573 B1.

### SUMMARY OF THE DISCLOSURE

It is the object of the present disclosure to provide a labeler whose transfer unit is easy to remove.

The structural design according to the present disclosure allows the transfer unit to be moved to an ergonomically advantageous handling position, at which it can also be handled by operators who are not very tall and/or physically unable to cope with heavy loads.

The transfer to the handling position may take place in any suitable way, preferably by pivoting or shifting, the special structural design depending on the construction of the labeler and being advantageously chosen in the way that is most expedient for the structural design of the respective labeler.

If the transfer unit is connected directly to a drive motor, i.e. if the transfer unit is attached to the motor shaft or an extension of the latter, it will be expedient to move the transfer unit together with the motor to a handling position at which it can be handled more easily.

According to preferred structural designs for moving the transfer unit to the handling position, the transfer unit may e.g. be supported on a hinge joint unit or on a linear bearing.

The invention can be applied to any kind of transfer unit, it may e.g. be used for gripper cylinders or vacuum cylinders or combinations of these principles.

### BRIEF DESCRIPTION OF THE SEVERAL VIEWS OF THE DRAWINGS

In the following, embodiments of the present invention will be explained in more detail making reference to the drawings, in which

FIG. 1 shows a top view of a labeling machine with a labeler according to the present disclosure, here configured as a module;

FIG. 2 shows an enlarged top view of a modular labeler with handling position; and

FIG. 3 shows an enlarged side view according to FIG. 1.

### DETAILED DESCRIPTION OF THE PREFERRED EMBODIMENTS

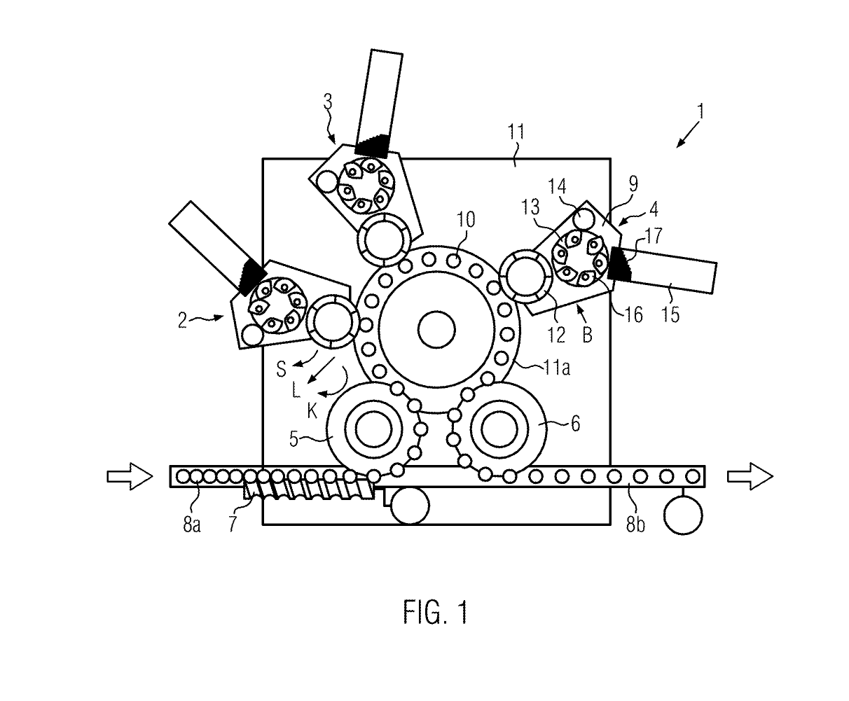

FIGS. 1 to 3 show in a highly schematic representation a labeling machine 1 comprising a table plate 11, which is supported by a lower frame and on which a rotary table 11a, an infeed star wheel 5 and a discharge star wheel 6 are rotatably supported. A separating screw 7, which is oriented parallel to a conveyor belt 8a, is arranged upstream of the infeed star wheel 5, and an additional conveyor belt 8b is arranged downstream of the discharge star wheel 6. The conveyor belts 8a, 8b, the separating screw 7, the infeed and discharge star wheels 5, 6 as well as the rotary table 11a serve to convey containers 10, the containers shown here being bottles, past at least one labeler 2, 3, 4. In the embodiment shown, three such labelers having substantially identical structural designs are provided.

Each labeler 2, 3, 4 comprises an assembly housing 9, which is positioned on the table plate 11. The normal components of such labelers are arranged on the top of the assembly housing 9, viz. a label container 15 with pre-cut labels 17, a glue roll 14, a transfer unit 12 for the labels and a rotor 13, which is adapted to be driven for rotation and provided with palette members 16 that are rotatable relative to the rotor 13. The palette members 16 remove the labels from the label container 15, move them past the glue roll 14 so as to apply glue thereto and transfer them subsequently to the transfer unit 12 that applies the labels at a predetermined location to the container 10, which rotates about its own axis and is moved past the respective labeler 2, 3, 4 by the rotary table 11a.

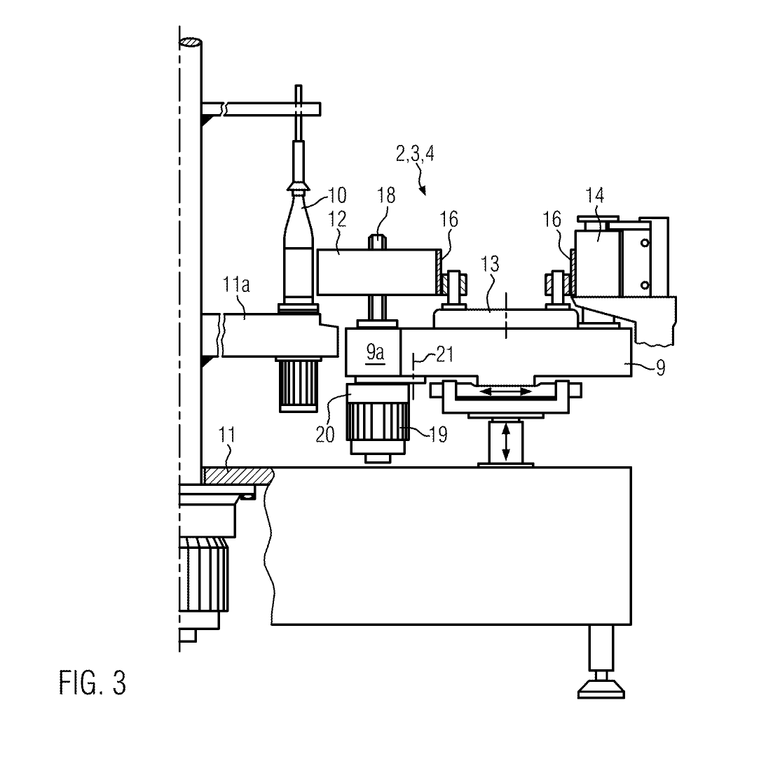

In the embodiment shown in FIGS. 1 and 3, the transfer unit 12 is configured as a gripper cylinder 12a, which is located at its operating position B, at which the labels 17 can be applied to the containers 10.

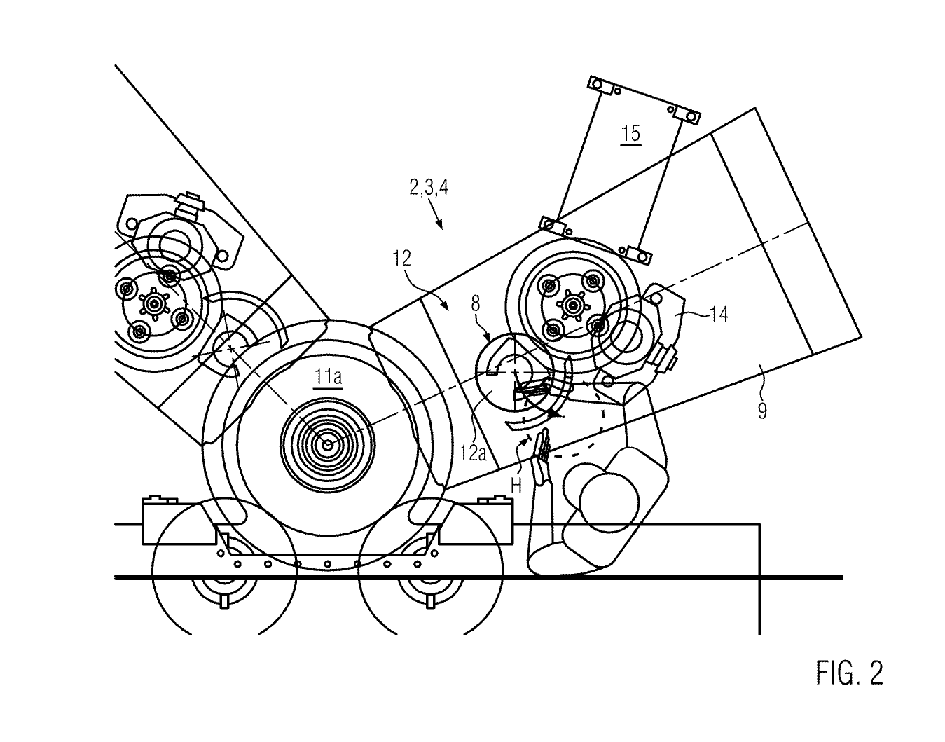

The transfer unit 12 can be removed from the assembly housing 9 and the labeler, respectively, as a unit or only with respect to specific components, for the purpose of inspection, maintenance or replacement. To this end, the transfer unit 12 must be raised (after having been unlocked), and this is laborious, energy-snapping and ergonomically unfavorable, since it must normally be done with arms extended, as outlined in FIG. 2.

In order to facilitate handling during the removal of the transfer unit 12, the transfer unit 12 is, prior to its removal, first moved from its operating position B to a handling position H, which has no operating function (FIG. 2) and at which the transfer unit 12 can be moved closer to the edge of the assembly housing 9 and thus closer to the position where the operator stands, so that it will be within easy reach of the operator. One of the possible handling positions H of the transfer unit 12 is indicated by a broken line in FIG. 2. At this handling position H, the transfer unit 12 can be raised and removed more easily and in an ergonomically more advantageous manner, since the operator has the transfer unit in full view from above and the heavy transfer unit is located closer to the operator's body.

The structural design allowing this handling position H is adapted to the special construction of the labelers 2, 3, 4 and of the transfer unit 12. The movement of the transfer unit 12 between the operating and handling positions B, H can take place by pivoting S (about a vertical axis), by tilting K (about a horizontal axis) or by shifting in a horizontal support L (straight or curved) and by arbitrary, expedient combinations of these possibilities.

From the structural point of view, the movement from the operating position B to the handling position H and back to the operating position B can be allowed by providing e.g. a kind of hinge joint or a linear bearing.

In the embodiment shown, the transfer unit 12 is attached to a vertical drive shaft 18 supported in the assembly housing 9 and acted upon by a motor 19 below said assembly housing 9. No matter whether the motor 19 drives only the transfer unit 12 or whether, e.g. via a gear mechanism 20, also other components of the labeler are driven by the motor 19, it will be expedient to move, together with the transfer unit 12, at least a drive shaft 18 and preferably also the motor 19 from the operating position B to the handling position H, so as to detach there the transfer unit 12, which has been unlocked, if necessary, either from the drive shaft 18, or the transfer unit 12 and the drive shaft 18 from the gear mechanism 20 and/or from the motor 19. In the embodiment shown, e.g. the gripper cylinder 12a with its drive shaft 18, the motor 19, the gear mechanism 20 and a bearing component 9a for the rotary shaft 18 in the assembly housing 9 are pivotable about a vertical axis 21 in a hinge-like fashion.

Finally, it should be pointed out that the above described invention is not limited to the shown structural design of a labeler. It may e.g. also be used for labeling units, which are adapted to be docked onto the container conveyor for replacement in a module-like fashion.

What is claimed is:

1. A labeler for a labeling machine for attaching labels to containers, comprising a transfer unit for transferring the labels to the container, said transfer unit being removably fixed at an operating position, prior to the removal, the transfer unit being first movable from its operating position to a handling position.

2. The labeler according to claim 1, the transfer unit (12) being connected to a motor and being movable to the handling position together with said motor.

3. The labeler according to claim 1 the transfer unit being arranged such that it is pivotable about a vertical axis.

4. The labeler according to claim 1 the transfer unit being tiltable about a horizontal axis.

5. The labeler according to claim 1 the transfer unit being shiftable.

6. The labeler according to claim 2 the motor connected to the transfer unit being supported on a hinge joint unit.

7. The labeler according to claim 2, the motor connected to the transfer unit being supported on a linear bearing.

8. The labeler according to one claim 1, the transfer unit comprising at least one of a gripper cylinder, vacuum cylinder, or a blade cylinder.
